(19) United States
(12) Patent Application Publication
(10) Pub. No.: US 2019/0042273 A1
(43) Pub. Date: Feb. 7, 2019

(54) Framework for Providing Calibration Alerts Using Unified Type System

(71) Applicant: SAP SE, Walldorf (DE)

(72) Inventors: Ke Chen, Foster City, CA (US); Feng Sun, Ashland, MA (US); Yu Jian Zhan, Shanghai (CN); Zhongyuan Huang, Shanghai (CN); He Wang, Shanghai (CN); JunKai Luo, Shanghai (CN); Jackie Burton, Naperville, IL (US); Brenda Reid, San Francisco, CA (US); Mayank Singh, Bangalore (IN); Jia Lin Dai, Shanghai (CN); Pan Zhang, Shanghai (CN); Qian Liu, Shanghai (CN); Bernhard Thimmel, Edingen-Neckarhausen (DE); Martin Scholz, NuBloch (DE); Heike Klews, Walldorf (DE); Johannes Fenzl, Rauenberg (DE); Simic Zhang, Shanghai (CN)

(21) Appl. No.: 15/669,171

(22) Filed: Aug. 4, 2017

(51) Int. Cl. G06F 9/44; G06F 9/54

(52) U.S. Cl. CPC G06F 9/443; G06F 9/54

(57) ABSTRACT

A rules engine is provided that can work with various heterogeneous calling applications. Such a rules engine can be part of a larger framework which, for example, can provide calibration alerts and the like when certain rule conditions are met. In some implementations, the framework can allow for the identification and mitigation of bias against certain employees and/or classes of employees within a larger organization.

### TECHNICAL FIELD

The subject matter described herein relates to a unifed type system including a rules engine that can work with different heterogeneous calling applications to provide calibration alerts.

### BACKGROUND

An increasing number of software applications are utilizing rules engines to execute rules when triggering actions occur. However, the rules engines for such applications are typically proprietary requiring custom rule definitions having unique formats to be generated for each application.

### SUMMARY

A rules engine is provided that can work with various heterogeneous calling applications. Such a rules engine can be part of a larger framework which, for example, can provide calibration alerts and the like when certain rule conditions are met. In some implementations, the framework can allow for the identification and mitigation of bias against certain employees and/or classes of employees within a larger organization.

In an interrelated aspect, an application programming interface (API) of a rules engine receives a request from a calling application to apply rules. Thereafter, it is resolved which objects should be exposed in response to the request. It can then be determined whether one or more fields in the objects to be exposed meet one or more conditions specified by the rules specified in the request. Data characterizing the determination can then be provided to the calling application.

The resolving can be supported by a meta data access component that identifies which objects should be exposed in response to the request.

A property resolver component can be called to determine additional properties associated with the request that are not specified in such request by the calling application.

A function implementation component can be called to execute additional functions associated with the calling application in application of the rules.

The rules can be associated with a bias determination within a company. In some cases, in response to the provided data (and optionally the data additional resolved by the rule engine and/or the executed functions), at least one alert is provided via a graphical user interface indicating the presence of potential bias.

The request can further specify object instances against which the rules are to be applied. In some variations, the request further encapsulates the object instances.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter enables the application of rules using a meta data approach that enables different heterogeneous applications to utilize a single external rules engine.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a sample unified type rules engine system;

FIG. 2 is a process flow diagram illustrating execution of rules by a unified type rules engine system;

FIG. 3 is a diagram illustrating a sample architecture for the creation and provision of alerts;

FIG. 4 is a diagram of a graphical user interface view showing an alert generated using, for example, the systems of FIG. 1 and FIG. 3; and

FIG. 5 is a diagram of a sample computing device for implementing aspects described herein.

### DETAILED DESCRIPTION

The current subject matter is directed to a rules engine that can work with various heterogeneous calling applications. Such a rules engine can be part of a larger framework which, for example, can provide calibration alerts and the like when certain rule conditions are met. In some implementations, the framework can allow for the identification and mitigation of bias against certain employees and/or classes of employees within a larger organization.

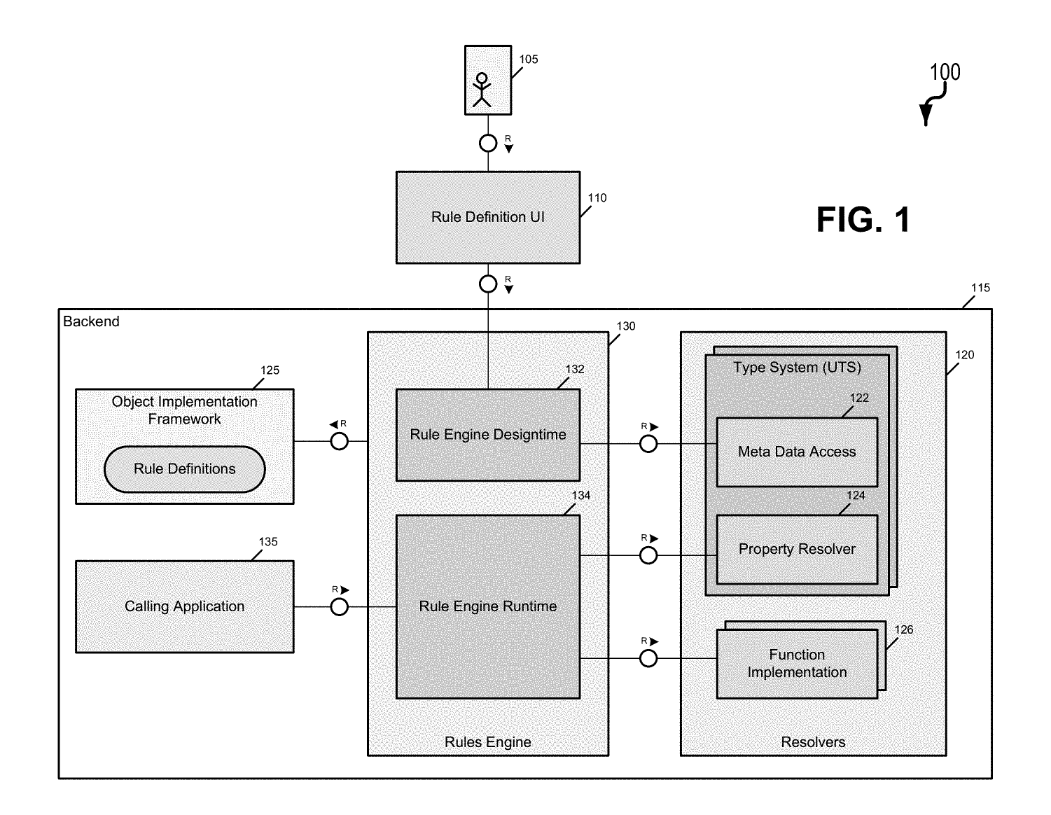

FIG. 1 is a system architecture diagram 100 illustrating a unified type system framework in which a user 105 can access a backend 115 (e.g., a server, a group of servers, servers and databases, etc.) via a rule definition UI 110. The rule definition UT 110 can provide a graphical user interface by which the user 105 can specify triggers for when certain rules should be run as well as the rules themselves (e.g., condition and action, etc.). The rule definition UI 110 calls into the backend 115 and, in particular, to a rules engine designtime component 132 forming part of a rules engine 130. The rules engine designtime component 132 can, for example, be exposed as an AJAX service. The rules engine designtime component can access a meta data access component 122 which, in turn, can be used to delegate to an object implementation framework (OIF) 125. The OIF 125, in turn, can comprises various OIF objects encapsulating various rule definitions. These rule definitions can, for example, specify which objects should be triggered, deleted, and/or saved and the like. The rule definitions can specify the triggers for when particular rules should be executed (when the rule is called). For example, a rule can be defined in an OIF object, and the rule definition for the OIF object can specify that the trigger is that whenever this OIF object changes, the rule is run.

The rules engine 130 can also include a rules engine runtime component 134 which can be called by calling applications 135. The calling applications 135 can specify which rules are to be run against which object instances and, in some variations, the calling applications 135 can also provide the object instances themselves. The rules engine runtime component 134 can provide information about which rules are to be executed and the effective time for such rules to be executed. The calling applications 135 can use heterogeneous formats which are either harmonized by the rules engine runtime component 134 or are responded to using a single format. Stated differently, the rules engine runtime component can provide top level/entrance data for rule execution. The objects returned by the rules engine runtime component 134 can be in a different phase than what is provided by the application so that the rule can be applied.

The rules engine runtime component 134 can delegate requests (by passing applicable objects) to a different rules engine such as rules engine utilizing MVFLEX Expression Language (MVEL). Further, the rules engine 130 can call a property resolver component 124 that can help identify any properties that are not specifically identified and which can affect the execution of applicable rules. Further, the rules engine 130 can call a function implementation component 126 for applications that have unique or otherwise new functions for use in connection with specific rules.

As one example, the calling application 135 can specify a rule—IF a.b.c=“124”—The calling application 135 can pass object instance corresponding to ‘a’ to the rules engine 130. The rules engine 130 can ask the property resolver 124 for ‘a’ to return value for ‘b’ on object instance of ‘a’. The property resolver 124 can then return an object instance of type ‘x’ (corresponding to the field type of ‘b’). Further, the rules engine 130 can ask property resolver 124 for ‘x’ to return value for ‘c’ on object instance of ‘x’ (a.b). The property resolver 123 can then return a string to the rules engine 130 which, in turn, then compares such string with ‘124’.

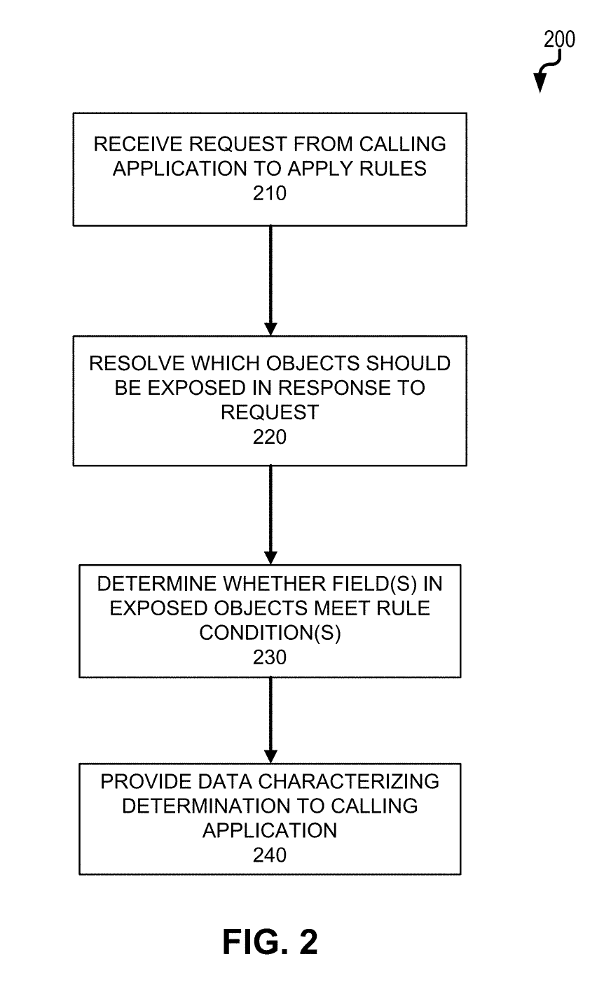

FIG. 2 is process flow diagram 200 in which, at 210 a request to apply rules is received by an application programming interface (API) of a rules engine from a calling application. Thereafter, at 220, objects which should be exposed in response to the request are resolved. Subsequently, at 230, it is determined whether one or more fields in the objects to be exposed meets one or more conditions specified by the rules specified in the request. Data is later provided to the calling application, at 240, that characterizes the determination.

The exposing of the objects can be an iterative process. In particular, in some variations, not all objects are resolved at once—but only those which are required for each part of the condition criteria or actions. This iteration can be done in a way to reduce processing resource consumption (only read those objects which are required because if one of the criteria is not met, the condition is not executed any further). If none of the conditions (if, else if, else if . . . ) are met, the rule is not executed any further. For everything which is not executed, no objects/properties are resolved.

In one implementation of the architecture of FIG. 1, the calling application 135 can relate to the detection of bias against particular employees or groups of employees and, more importantly, the prevention of bias against such employees. Bias is a particular difficult as some bias may be unconscious and unintentional and the decision makers may have some blind spots and are not aware of such bias. As a result, rules can be executed by the rules engine 130 which provide alerts indicating whether a particular proposed action or the like is indicative of bias. For example, the rules can provide that alerts are put in place to notify a user via a graphical user interface the effect of leave of absence on the performance/potential of a particular employee, a high year-on-year ratings but no promotion, and/or a quantified dramatic reduction in performance or potential of an employee in an underrepresented group.

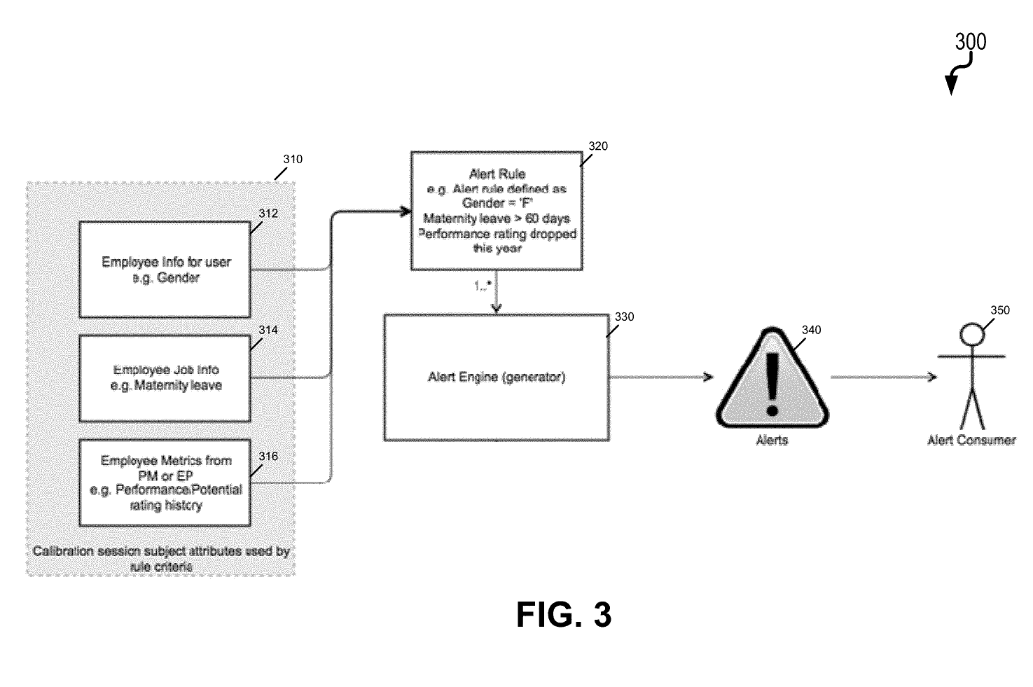

FIG. 3 is a diagram 300 illustrating an architecture for generating alerts using, for example, the framework illustrated in FIG. 1. During a calibration session 310 in which a user interacts with a graphical user interface to provide information about an employee various types of attributes can be specified. For example, at 312, employee information for the particular user can be specified (this is important because the gender and the role of the user can come into play with regard to bias). Further, the attributes can include information about the job of an employee 314 as well as various performance metrics 316 for the employee. Some or all of this attribute information can be passed to the rules engine runtime 134 (via a calling application) to see if the conditions of an alert are met (as defined by an alert rule 320). If the alert rule 320 includes a condition that requires an alert to be generated, an alert engine 330 causes an alert 340 to be generated and conveyed to the user 350. Stated differently, the alert engine 330 takes the alert rule 320 definition as well as the session subject data required by the rule definition, evaluates the rule by calling the rule engine 130 APIs and creates alerts based on the rule evaluation results. The alerts will be created for the session and consumed later when the user or other facilitator views the session in a graphical user interface.

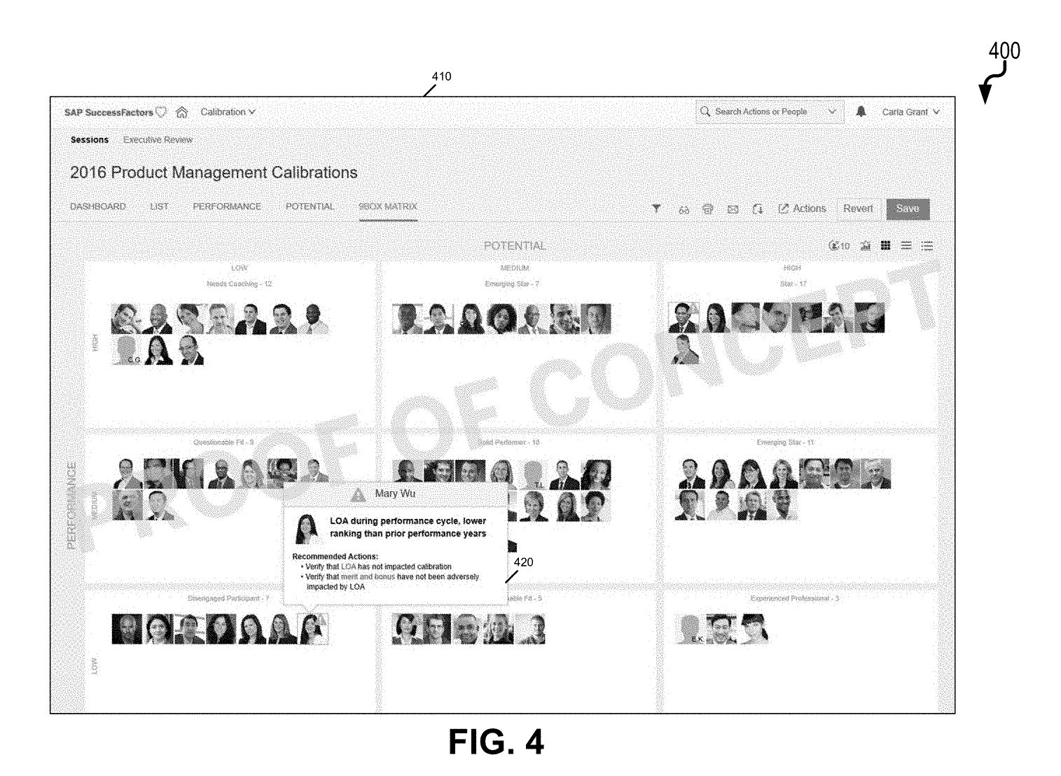

FIG. 4 is a diagram 400 illustrating a graphical user interface 410 that shows a calibration session. With this view, it shows a user-facing aspect of the GUI in which groups of employees are illustrated. These groups are based on potential and performance metrics for individual employees that can, for example, be based into respective groups of employees based on their responsibility and/or roles. In particular, the employees (as represented by GUI elements which can be activated to illustrate further information) are organized into nine different clusters. In the lower left cluster, which indicates employees with both low potential and low performance, an alert UI 420 is illustrated for a particular employee Mary Wu (generated, for example, using the rules engine 130 of FIG. 1 and the alert generator 330 of FIG. 3). This alert UI 420 indicates that this employee had a leave of absence (LOA) during the performance cycle and that her current ranking is lower than prior performance. This alert UI 420 can then be used by a human reviewer to verify that the LOA has not impacted her evaluation and to also verify that the LOA did not affect her merit and bonus. Other information can be displayed in connection with generated alerts as may be relevant to identify bias that may have inadvertently been applied using the potential and performance metrics.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, can include machine instructions for a programmable processor, and/or can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

The computer components, software modules, functions, data stores and data structures described herein can be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality can be located on a single computer or distributed across multiple computers depending upon the situation at hand.

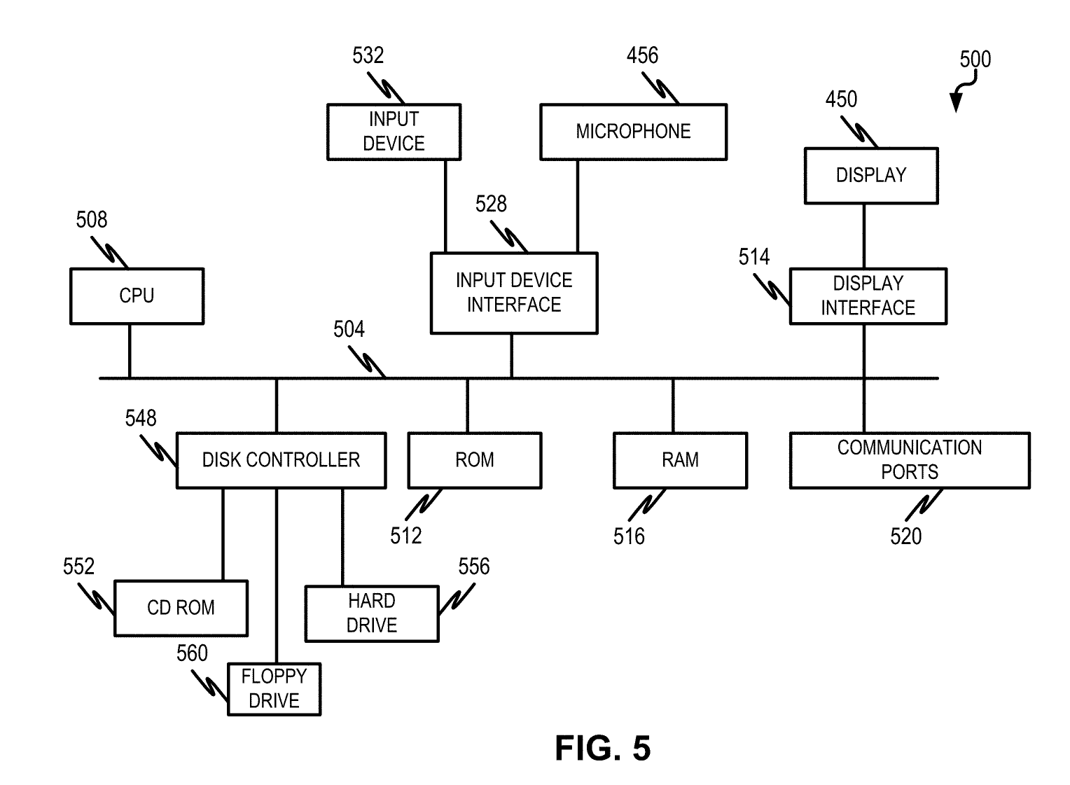

FIG. 5 is a diagram illustrating a sample computing device architecture for implementing various aspects described herein. A bus 504 can serve as the information highway interconnecting the other illustrated components of the hardware. A processing system 508 labeled CPU (central processing unit) (e.g., one or more computer processors/data processors at a given computer or at multiple computers), can perform calculations and logic operations required to execute a program. A non-transitory processor-readable storage medium, such as read only memory (ROM) 512 and random access memory (RAM) 516, can be in communication with the processing system 508 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 548 can interface one or more optional disk drives to the system bus 504. These disk drives can be external or internal floppy disk drives such as 560, external or internal CD-ROM, CD-R, CD-RW or DVD, or solid state drives such as 552, or external or internal hard drives 556. As indicated previously, these various disk drives 552, 556, 560 and disk controllers are optional devices. The system bus 504 can also include at least one communication port 520 to allow for communication with external devices either physically connected to the computing system or available externally through a wired or wireless network. In some cases, the communication port 520 includes or otherwise comprises a network interface.

To provide for interaction with a user, the subject matter described herein can be implemented on a computing device having a display device 540 (e.g., a CRT (cathode ray tube) or LCD (liquid crystal display) monitor) for displaying information obtained from the bus 504 to the user and an input device 532 such as keyboard and/or a pointing device (e.g., a mouse or a trackball) and/or a touchscreen by which the user can provide input to the computer. Other kinds of devices can be used to provide for interaction with a user as well; for example, feedback provided to the user can be any form of sensory feedback (e.g., visual feedback, auditory feedback by way of a microphone 536, or tactile feedback); and input from the user can be received in any form, including acoustic, speech, or tactile input. In the input device 532 and the microphone 536 can be coupled to and convey information via the bus 504 by way of an input device interface 528. Other computing devices, such as dedicated servers, can omit one or more of the display 540 and display interface 524, the input device 532, the microphone 536, and input device interface 528.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method comprising:
receiving, by an application programming interface (API) of a rules engine from a calling application, a request to apply rules;
resolving which objects should be exposed in response to the request;
determining whether one or more fields in the objects to be exposed meet one or more conditions specified by the rules specified in the request; and
providing data characterizing the determining to the calling application;
wherein the objects are exposed in an iterative manner based on which condition requires such object.

2. The method of claim 1, wherein the resolving is supported by a meta data access component that identifies which objects should be exposed in response to the request.

3. The method of claim 1 further comprising: calling a property resolver component to determine additional properties associated with the request that were not passed by the calling application.

4. The method of claim 1 further comprising: calling a function implementation component to execute additional functions associated with the calling application in application of the rules.

5. The method of claim 1, wherein the rules are associated with a bias determination within a company against an employee or group of employees.

6. The method of claim 5, wherein, in response to the provided data, at least one alert is provided via a graphical user interface indicating a presence of potential bias.

7. The method of claim 1, wherein the request further specifies object instances against which the rules are to be applied.

8. The method of claim 7, wherein the request further encapsulates the object instances.

9. A system comprising:
at least one data processor; and
memory storing instructions which, when executed by the at least one data processor, result in operations comprising:
receiving, by an application programming interface (API) of a rules engine from a calling application, a request to apply rules;
resolving which objects should be exposed in response to the request;
determining whether one or more fields in the objects to be exposed meet one or more conditions specified by the rules specified in the request; and
providing data characterizing the determining to the calling application.

10. The system of claim 9, wherein the resolving is supported by a meta data access component that identifies which objects should be exposed in response to the request.

11. The system of claim 9, wherein the operations further comprise:
calling a property resolver component to determine additional properties associated with the request that were not passed by the calling application.

12. The system of claim 9, wherein the operations further comprise: calling a function implementation component to execute additional functions associated with the calling application in application of the rules.

13. The system of claim 9, wherein the rules are associated with a bias determination within a company against an employee or group of employees.

14. The system of claim 13, wherein, in response to the provided data, at least one alert is provided via a graphical user interface indicating athc presence of potential bias.

15. The system of claim 9, wherein the request further specifies object instances against which the rules are to be applied.

16. The system of claim 15, wherein the request further encapsulates the object instances.

17. A non-transitory computer program product storing instructions which, when executed by at least one data processor, result in operations comprising:
receiving, by an application programming interface (API) of a rules engine from a calling application, a request to apply rules;
resolving which objects should be exposed in response to the request;
determining whether one or more fields in the objects to be exposed meet one or more conditions specified by the rules specified in the request; and
providing data characterizing the determining to the calling application.

18. The non-transitory computer program product of claim 17, wherein: the resolving is supported by a meta data access component that identifies which objects should be exposed in response to the request.

19. The non-transitory computer program product of claim 17, wherein the operations further comprise: calling a property resolver component to determine additional properties associated with the request that were not passed by the calling application.

20. The non-transitory computer program product of claim 17, wherein:
the operations further comprise: calling a function implementation component to execute additional functions associated with the calling application in application of the rules;
the rules are associated with a bias determination within a company against an employee or group of employees;
the request further specifies object instances against which the rules are to be applied; and
the request further encapsulates the object instances.
